(19) United States
(12) Patent Application Publication
(10) Pub. No.: US 2019/0137300 A1
(43) Pub. Date: May 9, 2019

(54) CAPACITIVE SENSOR WITH CAPACITANCE TO DISPLACEMENT CONVERSION AND CAPACITANCE TO DISPLACEMENT RATE CONVERSION

(71) Applicant: Cirrus Logic International Semiconductor Ltd., Edinburgh (GB)

(72) Inventors: Amar VELLANKI, Cedar Park, TX (US); Vamsikrishna PARUPALLI, Austin, TX (US); Emmanuel MARCHAIS, Dripping Springs, TX (US); Zhong YOU, Austin, TX (US)

(73) Assignee: Cirrus Logic International Semiconductor Ltd., Edinburgh (GB)

(21) Appl. No.: 15/926,758

(22) Filed: Mar. 20, 2018

Related U.S. Application Data
(60) Provisional application No. 62/583,769, filed on Nov. 9, 2017.

(51) Int. Cl. G01D 5/24; H04R 29/00

(52) U.S. Cl. CPC G01D 5/24; H04R 29/001

(57) ABSTRACT

A method may include receiving an analog modulated signal generated from a baseband signal modulated with a carrier signal wherein the baseband signal is representative of a capacitance of a capacitive sensor, converting the analog modulated signal into an equivalent digital modulated signal, demodulating the digital modulated signal to generate a demodulated digital signal representative of the capacitance of the capacitor wherein the demodulating is based, at least in part, on the carrier signal, and converting the demodulated digital signal into a digital output signal representative of a displacement of a plate of the capacitive sensor or a rate of displacement of a plate of the capacitive sensor.

### CROSS-REFERENCE AND RELATED APPLICATION

The present disclosure claims benefit of U.S. Provisional Patent Application Ser. No. 62/583,769, filed Nov. 9, 2017, which is incorporated by reference herein in its entirety.

### FIELD OF DISCLOSURE

The present disclosure relates in general to measuring capacitance, and more specifically, to systems and methods for measuring capacitance using a capacitance to voltage converter and deriving displacement and rate of displacement from the measured capacitance.

### BACKGROUND

In many electrical and electronic systems, it may be desirable to measure a capacitance within a circuit in order to take action responsive to the measured capacitance. For example, a capacitive sensor used in an audio speaker may be used to sense a position of a transducer diaphragm of the audio speaker. The capacitance value of a capacitive sensor which changes responsive to an audio signal driven through the speaker may be measured by driving a carrier tone on one terminal of the speaker and sensing a modulated signal current on the other terminal. One type of apparatus for measuring capacitance is known as a capacitance-to-digital converter, or “CDC,” which is capable of measuring a capacitance and generating a digital output signal indicative of a magnitude of the measured capacitance.

### SUMMARY

In accordance with the teachings of the present disclosure, certain disadvantages and problems associated with performance of existing capacitance-to-digital converters have been reduced or eliminated.

In accordance with embodiments of the present disclosure, a method may include receiving an analog modulated signal generated from a baseband signal modulated with a carrier signal wherein the baseband signal is representative of a capacitance of a capacitive sensor, converting the analog modulated signal into an equivalent digital modulated signal, demodulating the digital modulated signal to generate a demodulated digital signal representative of the capacitance of the capacitor wherein the demodulating is based, at least in part, on the carrier signal, and converting the demodulated digital signal into a digital output signal representative of a displacement of a plate of the capacitive sensor.

In accordance with these and other embodiments of the present disclosure, a method may include receiving an analog modulated signal generated from a baseband signal modulated with a carrier signal wherein the baseband signal is representative of a capacitance of a capacitive sensor, converting the analog modulated signal into an equivalent digital modulated signal, demodulating the digital modulated signal to generate a demodulated digital signal representative of the capacitance of the capacitor wherein the demodulating is based, at least in part, on the carrier signal, and converting the demodulated digital signal into a digital output signal representative of a rate of displacement of a plate of the capacitive sensor.

In accordance with these and other embodiments of the present disclosure, a system may include an input configured to receive an analog modulated signal generated from a baseband signal modulated with a carrier signal wherein the baseband signal is representative of a capacitance of a capacitive sensor, an analog-to-digital converter configured to convert the analog modulated signal into an equivalent digital modulated signal, a demodulator configured to demodulate the digital modulated signal to generate a demodulated digital signal representative of the capacitance of the capacitor wherein the demodulator is configured to demodulate based, at least in part, on the carrier signal, and a converter configured to convert the demodulated digital signal into a digital output signal representative of a displacement of a plate of the capacitive sensor.

In accordance with these and other embodiments of the present disclosure, a system may include an input configured to receive an analog modulated signal generated from a baseband signal modulated with a carrier signal wherein the baseband signal is representative of a capacitance of a capacitive sensor, an analog-to-digital converter configured to convert the analog modulated signal into an equivalent digital modulated signal, a demodulator configured to demodulate the digital modulated signal to generate a demodulated digital signal representative of the capacitance of the capacitor wherein the demodulator is configured to demodulate based, at least in part, on the carrier signal, and a converter configured to convert the demodulated digital signal into a digital output signal representative of a rate of displacement of a plate of the capacitive sensor.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 is a block diagram of selected components of an example capacitance-sensing circuit, in accordance with embodiments of the present disclosure;

FIG. 2 is a flow chart of an example method for using a capacitance-sensing circuit to sense displacement of a capacitive sensor, in accordance with embodiments of the present disclosure; and

FIG. 3 is a flow chart of an example method for using a capacitive sensor to sense a rate of displacement of a capacitive sensor, in accordance with embodiments of the present disclosure.

### DETAILED DESCRIPTION

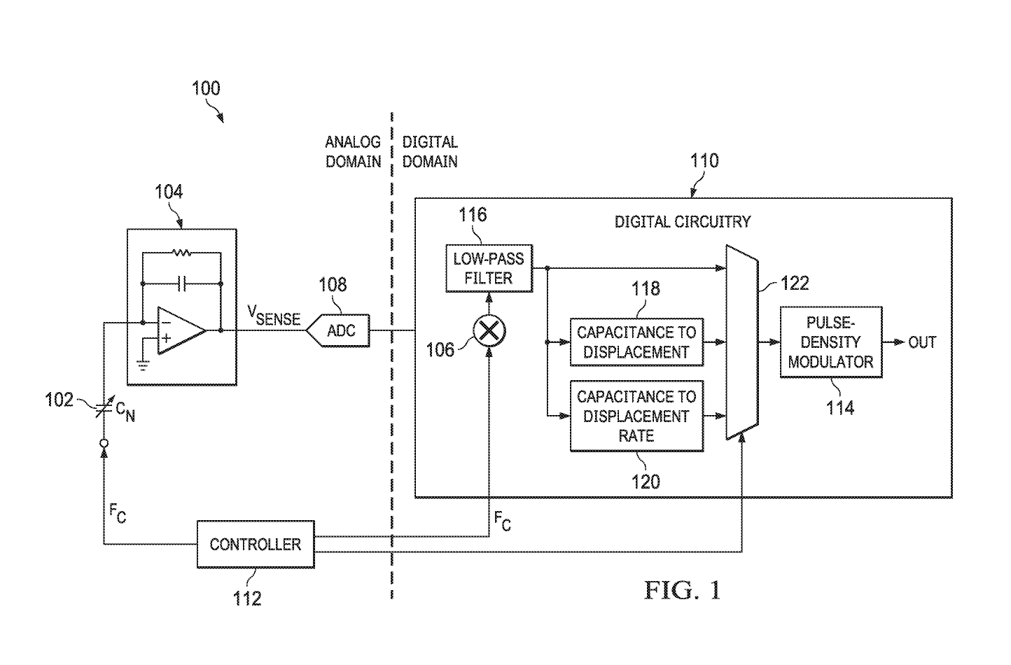

FIG. 1 is a block diagram of selected components of an example capacitance-sensing circuit 100 for sensing a variable capacitance C_{M} of a component 102, wherein carrier demodulation is implemented in a digital domain, in accordance with embodiments of the present disclosure. In some embodiments, component 102 may comprise an audio speaker and capacitance C_{M} may be representative of a displacement of an audio transducer of such audio speaker. However, the systems and methods disclosed herein are not limited to measuring displacement in an audio speaker, and may be applied to any suitable measuring or sensing of a capacitance.

As shown in FIG. 1, capacitance-sensing circuit 100 may include a capacitance-to-voltage converter (CVC) 104, an analog-to-digital converter (ADC) 108, digital circuitry 110, and a controller 112. CVC 104 may comprise a charge integrator configured to integrate charge at its input to generate a voltage signal V_{SENSE} indicative of capacitance C_{M} of component 102. Such voltage signal V_{SENSE} may be generated by applying an excitation signal at a carrier frequency f_{C} to one of the terminals of capacitance C_{M} of component 102, which may cause generation of a modulated voltage signal V_{SENSE} from a baseband signal indicative of capacitance C_{M}, wherein the excitation signal is of a carrier frequency f_{C} which is higher than frequency content of the baseband signal.

ADC 108 may convert modulated voltage signal V_{SENSE} into an equivalent modulated digital signal that may be further processed by digital circuitry 110. As shown in FIG. 1, ADC 108 may define a boundary between an analog domain of a signal path of capacitance-sensing circuit 100 and a digital domain of the signal path of capacitance-sensing circuit 100.

As also depicted in FIG. 1, digital circuitry 110 may include a demodulator 106, a low-pass filter 116, a capacitance-to-displacement converter 118, a capacitance-to-displacement-rate converter 120, a multiplexer 122, and a pulse-density modulator 114. Demodulator 106 may demodulate the modulated digital signal from ADC 108 at the carrier frequency f_{C} in a digital domain of capacitance-sensing circuit 100 to generate a digital signal representative of a capacitance of the capacitor wherein the demodulating is based, at least in part, on the excitation signal. For example, the demodulation signal received by demodulator 106 may comprise a sine wave at carrier frequency f_{C}.

Low-pass filter 116 may be configured to filter out frequency components of the digital signal generated by demodulator 106 which are outside a band of interest. For example, in audio applications, low-pass filter 116 may filter out frequency components of the digital signal generated by demodulator 106 which are outside the audible frequency band.

Capacitance-to-displacement converter 118 may be any system, device, or apparatus configured to convert the filtered digital signal generated by low-pass filter 116, which may be representative of a capacitance C_{M} of component 102, into a digital output signal representative of a displacement of a plate of the capacitor of component 102.

Capacitance-to-displacement-rate converter 120 may be any system, device, or apparatus configured to convert the filtered digital signal generated by low-pass filter 116, which may be representative of a capacitance C_{M} of component 102, into a digital output signal representative of a rate of a displacement of a plate of the capacitor of component 102. In audio applications, in which component 102 is an audio speaker, such rate of displacement may be representative of a sound pressure generated by the audio speaker.

Multiplexer 122 may be any system, device, or apparatus configured to, based on a control signal (e.g., communicated from controller 112), select for output one of the capacitance signal generated by low-pass filter 116, the displacement signal generated by capacitance-to-displacement converter 118, and the rate-of-displacement signal generated by capacitance-to-displacement-rate converter 120.

Pulse-density modulator 114 may comprise any system, device, or apparatus configured to receive the digital signal selected by multiplexer 122 and modulate such signal to create an equivalent pulse-density modulated signal OUT.

Controller 112 may be configured to apply the excitation signal to one of the terminals of capacitance C_{M} of component 102 as described above. In some embodiments, such excitation signal may comprise a square-wave signal. Controller 112 may also be configured to generate a digital equivalent of the excitation signal (e.g., a sine wave at carrier frequency f_{C}) to demodulator 106 such that demodulator 106 demodulates the modulated digital signal generated by ADC 108 as described above.

Further, controller 112 may be configured to generate a control signal to multiplexer 122 to select for output one of the capacitance signal generated by low-pass filter 116, the displacement signal generated by capacitance-to-displacement converter 118, and the rate-of-displacement signal generated by capacitance-to-displacement-rate converter 120.

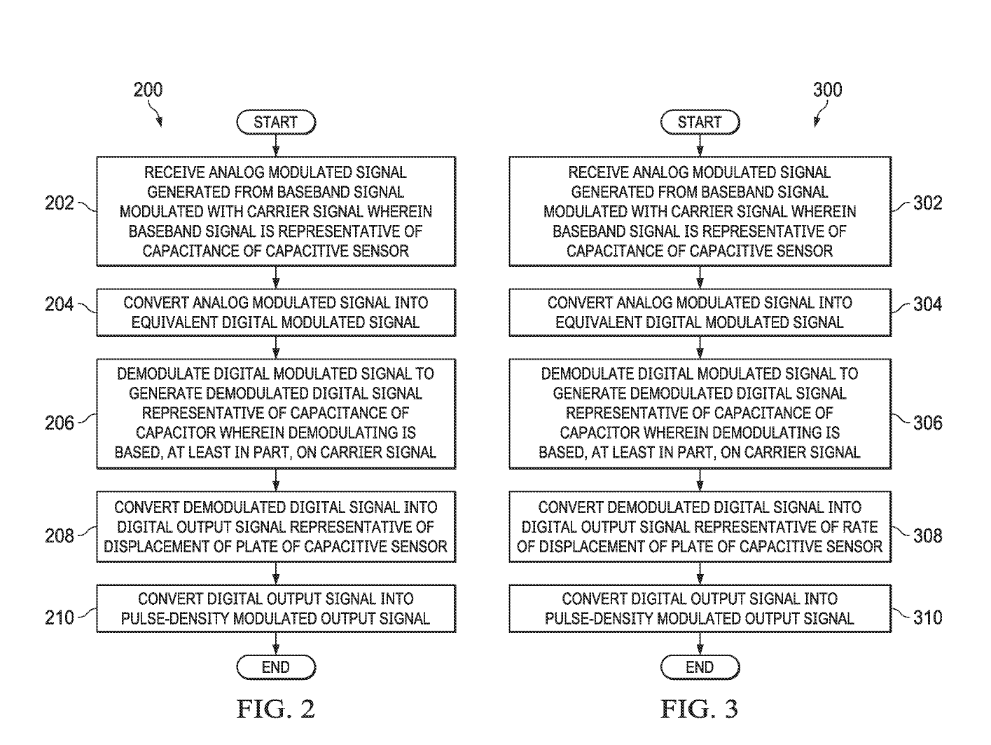

FIG. 2 is a flow chart of an example method 200 for using a capacitance-sensing circuit to sense displacement of a capacitive sensor, in accordance with embodiments of the present disclosure. According to certain embodiments, method 200 may begin at step 202. As noted above, teachings of the present disclosure may be implemented in a variety of configurations of a capacitive sensing circuit. As such, the preferred initialization point for method 200 and the order of the steps comprising method 200 may depend on the implementation chosen. In these and other embodiments, method 200 may be implemented as firmware, software, applications, functions, libraries, or other instructions.

At step 202, analog-to-digital converter 108 may receive an analog modulated signal generated from a baseband signal modulated with a carrier signal (e.g., having carrier frequency f_{C}) wherein the baseband signal is representative of a capacitance C_{M} of a capacitive sensor (e.g., within component 102). At step 204, analog-to-digital converter 108 may convert the analog modulated signal into an equivalent digital modulated signal. At step 206, demodulator 106 may demodulate the digital modulated signal to generate a demodulated digital signal representative of the capacitance of the capacitor wherein the demodulating is based, at least in part, on the carrier signal. At step 208, capacitance-to-displacement converter 118 may convert the demodulated digital signal into a digital output signal representative of a displacement of a plate of the capacitive sensor. At step 210, pulse-density modulator 114 may convert the digital output signal into a pulse-density modulated output signal.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using capacitance-sensing circuit 100, components thereof or any other system operable to implement method 200. In certain embodiments, method 200 may be implemented partially or fully in software and/or firmware embodied in computer-readable media.

FIG. 3 is a flow chart of an example method 300 for using a capacitance-sensing circuit to sense a rate of displacement of a capacitive sensor, in accordance with embodiments of the present disclosure. According to certain embodiments, method 300 may begin at step 302. As noted above, teachings of the present disclosure may be implemented in a variety of configurations of a capacitive sensing circuit. As such, the preferred initialization point for method 300 and the order of the steps comprising method 300 may depend on the implementation chosen. In these and other embodiments, method 300 may be implemented as firmware, software, applications, functions, libraries, or other instructions.

At step 302, analog-to-digital converter 108 may receive an analog modulated signal generated from a baseband signal modulated with a carrier signal (e.g., having carrier frequency f_{C}) wherein the baseband signal is representative of a capacitance C_{M} of a capacitive sensor (e.g., within component 102). At step 304, analog-to-digital converter 108 may convert the analog modulated signal into an equivalent digital modulated signal. At step 306, demodulator 106 may demodulate the digital modulated signal to generate a demodulated digital signal representative of the capacitance of the capacitor wherein the demodulating is based, at least in part, on the carrier signal. At step 308, capacitance-to-displacement-rate converter 120 may convert the demodulated digital signal into a digital output signal representative of a rate of displacement of a plate of the capacitive sensor. At step 310, pulse-density modulator 114 may convert the digital output signal into a pulse-density modulated output signal.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using sensing circuit 100, components thereof or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding this disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method comprising:
receiving an analog modulated signal generated from a baseband signal modulated with a carrier signal wherein the baseband signal is representative of a capacitance of a capacitive sensor;
converting the analog modulated signal into an equivalent digital modulated signal;
demodulating the digital modulated signal to generate a demodulated digital signal representative of the capacitance of the capacitor wherein the demodulating is based, at least in part, on the carrier signal; and
converting the demodulated digital signal into a digital output signal representative of a displacement of a plate of the capacitive sensor.

2. The method of claim 1, wherein the displacement is representative of a displacement of a transducer.

3. The method of claim 2, wherein the transducer comprises one of a speaker, a linear resonant actuator, and a haptic transducer.

4. The method of claim 1, further comprising converting the digital output signal into a pulse-density modulated output signal with a pulse-density modulator.

5. A method comprising:
receiving an analog modulated signal generated from a baseband signal modulated with a carrier signal wherein the baseband signal is representative of a capacitance of a capacitive sensor;
converting the analog modulated signal into an equivalent digital modulated signal;
demodulating the digital modulated signal to generate a demodulated digital signal representative of the capacitance of the capacitor wherein the demodulating is based, at least in part, on the carrier signal; and
converting the demodulated digital signal into a digital output signal representative of a rate of displacement of a plate of the capacitive sensor.

6. The method of claim 5, wherein the rate of displacement is representative of a rate of displacement of a transducer.

7. The method of claim 6, wherein the transducer comprises one of a speaker, a linear resonant actuator, and a haptic transducer.

8. The method of claim 6, wherein the transducer comprises a speaker, and the rate of displacement is representative of a sound pressure.

9. The method of claim 5, further comprising converting the digital output signal into a pulse-density modulated output signal with a pulse-density modulator.

10. A system comprising:
an input configured to receive an analog modulated signal generated from a baseband signal modulated with a carrier signal wherein the baseband signal is representative of a capacitance of a capacitive sensor;
an analog-to-digital converter configured to convert the analog modulated signal into an equivalent digital modulated signal;
a demodulator configured to demodulate the digital modulated signal to generate a demodulated digital signal representative of the capacitance of the capacitor wherein the demodulator is configured to demodulate based, at least in part, on the carrier signal; and
a converter configured to convert the demodulated digital signal into a digital output signal representative of a displacement of a plate of the capacitive sensor.

11. The system of claim 10, wherein the displacement is representative of a displacement of a transducer.

12. The system of claim 11, wherein the transducer comprises one of a speaker, a linear resonant actuator, and a haptic transducer.

13. The system of claim 10, further comprising a pulse-density modulator configured to convert the digital output signal into a pulse-density modulated output signal.

14. A system comprising:
an input configured to receive an analog modulated signal generated from a baseband signal modulated with a carrier signal wherein the baseband signal is representative of a capacitance of a capacitive sensor;
an analog-to-digital converter configured to convert the analog modulated signal into an equivalent digital modulated signal;
a demodulator configured to demodulate the digital modulated signal to generate a demodulated digital signal representative of the capacitance of the capacitor wherein the demodulator is configured to demodulate based, at least in part, on the carrier signal; and
a converter configured to convert the demodulated digital signal into a digital output signal representative of a rate of displacement of a plate of the capacitive sensor.

15. The system of claim 14, wherein the rate of displacement is representative of a rate of displacement of a transducer.

16. The system of claim 15, wherein the transducer comprises one of a speaker, a linear resonant actuator, and a haptic transducer.

17. The system of claim 15, wherein the transducer comprises a speaker, and the rate of displacement is representative of a sound pressure.

18. The system of claim 14, further comprising a pulse-density modulator configured to convert the digital output signal into a pulse-density modulated output signal.
